(19) United States
(12) Patent Application Publication
(10) Pub. No.: US 2024/0128818 A1
(43) Pub. Date: Apr. 18, 2024

(54) ROTOR AND MOTOR

(71) Applicant: Mitsuba Corporation, Gunma (JP)

(72) Inventors: Ryo Ohori, Kiryu-shi (JP); Takeshi Kanai, Kiryu-shi (JP)

(21) Appl. No.: 18/547,881

(22) PCT Filed: Mar. 4, 2022
(86) PCT No.: PCT/JP2022/009539

§ 371 Date: Aug. 25, 2023

(30) Foreign Application Priority Data
Mar. 9, 2021 (JP) 2021-037408

(51) Int. Cl. H02K 1/278

(52) U.S. Cl. CPC H02K 1/278; H02K 2213/03

(57) ABSTRACT

A rotor core includes: a plurality of salient poles that protrude outward in a radial direction from a rotor core main body portion and are arranged between magnets which are adjacent to each other in a circumferential direction, a holder includes: an annular portion that is arranged to overlap an end surface in an axial direction of the rotor core main body portion; and a leg portion that protrudes outward in a radial direction from the annular portion and is arranged to overlap an end surface in an axial direction of the salient poles, and a press fit rib in which a magnet cover is pressed into the leg portion is provided on an outer end section in a radial direction of the leg portion.

### TECHNICAL FIELD

The present invention relates to a rotor and a motor.

Priority is claimed on Japanese Patent Application No. 2021-037408, filed on Mar. 9, 2021, the contents of which are incorporated herein by reference.

### BACKGROUND

As a rotor of a motor that includes a plurality of magnets, a rotor is known which includes a rotor core having a plurality of salient poles on an outer circumferential surface. The plurality of salient poles is formed at intervals in a circumferential direction. The plurality of salient poles protrudes outward in a radial direction from the outer circumferential surface of the rotor core. Each of the plurality of magnets is fixed to the outer circumferential surface of the rotor core at a position between salient poles that are adjacent to each other in the circumferential direction.

The rotor may include a holder for performing positioning of the magnet from both sides in an axial direction of the rotor core. The rotor may include a magnet cover having a cylindrical thin plate shape that covers outer circumferential surfaces of the magnet and the rotor core in order to protect the magnet. In this case, the magnet cover is pressed into the outer circumferential surface of the magnet from one end side in the axial direction of the rotor core. Then, an end portion in an axial direction of the magnet cover is folded back inward in the radial direction and is swaged throughout the entire circumference, and thereby the magnet is assembled to the rotor core.

### RELATED ART DOCUMENTS

### Patent Documents

### [Patent Document 1]

Japanese Patent No. 5776652

### SUMMARY OF INVENTION

### Problems to be Solved by the Invention

The magnet cover is assembled to the magnet by press-fitting. At the time of this press-fitting, the magnet cover is pressed into the magnet. Therefore, this pressed portion may be pulled outward in the radial direction and be expanded outward in the radial direction. In accordance with this deformation, a portion that faces a salient pole in the radial direction in the magnet cover (hereinafter, referred to as a salient pole-facing portion of the magnet cover) may deform so as to shrink inward in the radial direction.

As a result, the magnet cover and the salient pole may come into contact with each other. At this time, a press fit load at the salient pole-facing portion of the magnet cover is increased, and there is a possibility that the magnet cover is deformed or broken. The magnet holder abuts a tool at the time of press-fitting of the magnet cover. Therefore, when the press fit load of the magnet cover becomes excessive, breakage may occur due to the load.

Accordingly, the present invention provides a rotor and a motor capable of preventing an increase in a press fit load of a magnet cover and preventing the magnet cover and a magnet holder from being deformed and broken.

### Means for Solving the Problem

In order to solve the problem described above, a rotor according to the present invention includes: a rotor core that rotates integrally with a rotation shaft; a plurality of magnets that are arranged on the outer circumferential surface of the rotor core; a magnet cover which covers an outside of the magnets and the rotor core, into which the magnets are pressed, which includes a flange portion that is formed on an end portion in an axial direction and is bent inward in a radial direction, and which has a cylindrical shape; and a holder that is arranged between the flange portion and an end surface in an axial direction of the rotor core and is in contact with the flange portion and the rotor core, wherein the rotor core includes: a core main body portion that is fitted and fixed to the rotation shaft and has a cylindrical shape; and a plurality of salient poles that protrude outward in a radial direction from the core main body portion and are arranged between the magnets which are adjacent to each other in a circumferential direction, the holder includes: an annular portion that is arranged to overlap an end surface in an axial direction of the core main body portion; and a leg portion that protrudes outward in a radial direction from the annular portion and is arranged to overlap an end surface in an axial direction of the salient poles, and a press fit rib in which the magnet cover is pressed into the leg portion is provided on at least one of an outer end section in a radial direction of the leg portion and a portion of the magnet cover that faces, in a radial direction, the outer end section in the radial direction of the leg portion.

### Advantage of the Invention

According to the present invention, it is possible to provide a rotor and a motor capable of preventing an increase in a press fit load of a magnet cover and preventing the magnet cover and a magnet holder from being deformed and broken.

### BRIEF DESCRIPTION OF THE DRAWINGS

FIG. 1 is a perspective view of a motor unit of a first embodiment.

FIG. 2 is a cross-sectional view along a II-II line of FIG. 1 of the motor unit of the first embodiment.

FIG. 3 is a perspective view of a rotor of the first embodiment.

FIG. 4 is a cross-sectional view along a IV-IV line of FIG. 3 of the rotor of the first embodiment.

FIG. 5 is an enlarged cross-sectional view of a V portion in FIG. 4 of the rotor of the first embodiment.

FIG. 6 is an exploded perspective view of the rotor of the first embodiment.

FIG. 7 is a perspective view of the rotor of the first embodiment from which a magnet cover is removed.

FIG. 8A is a perspective view of a holder of the first embodiment when seen from another end side in an axial direction.

FIG. 8B is a perspective view of the holder of the first embodiment when seen from one end side in the axial direction.

FIG. 9A is a process view showing an assembly method of the magnet cover of the first embodiment.

FIG. 9B is a process view showing the assembly method of the magnet cover of the first embodiment.

FIG. 9C is a process view showing the assembly method of the magnet cover of the first embodiment.

FIG. 10 is a view showing deformation prevention of the magnet cover by a press fit rib of the first embodiment.

FIG. 11 is a graph showing the effects of preventing variation of a press fit load by the press fit rib of the first embodiment.

FIG. 12 is a cross-sectional view of a rotor of a second embodiment.

### DESCRIPTION OF THE EMBODIMENTS

### First Embodiment

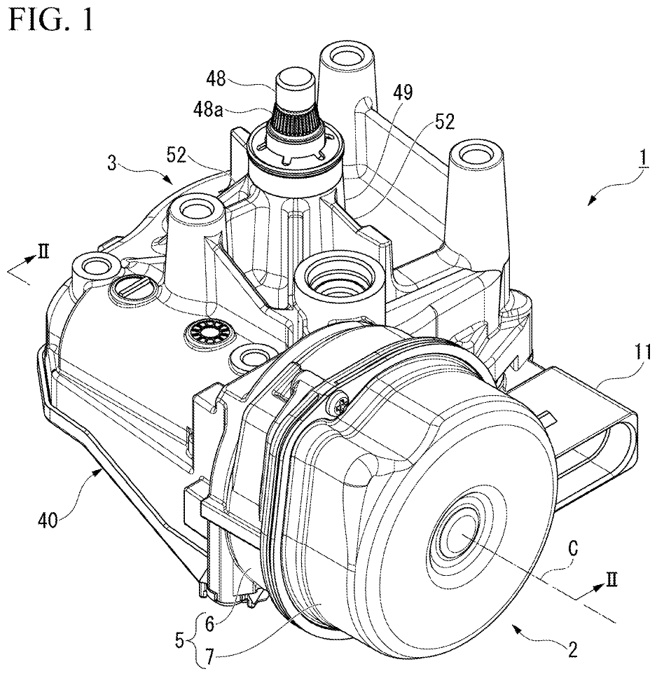

Hereinafter, a first embodiment of the present invention will be described with reference to FIG. 1 to FIG. 11.

### (Motor Unit)

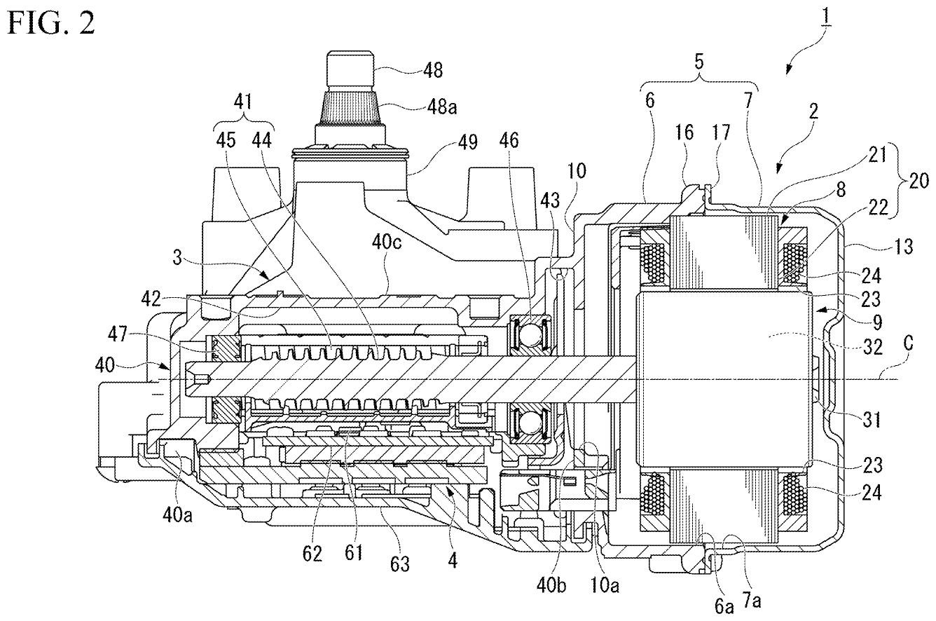

FIG. 1 is a perspective view of a motor unit 1. FIG. 2 is a cross-sectional view along a II-II line of FIG. 1 of the motor unit 1.

The motor unit 1 is used, for example, as a drive source of a wiper device of a vehicle. As shown in FIG. 1 and FIG. 2, the motor unit 1 includes a motor 2, a speed reduction portion 3 that slows down the rotation of the motor 2 and outputs the rotation, and a controller 4 that performs drive control of the motor 2.

In the following description, the term “axial direction” means a direction along a rotation axis line direction of a rotation shaft 31 of the motor 2, and the term “circumferential direction” means a circumferential direction of the rotation shaft 31. The term “radial direction” means a radial direction of the rotation shaft 31.

### (Motor)

The motor 2 includes a motor case 5, a stator 8 that is stored in the motor case 5 and has a cylindrical shape, and a rotor 9 that is arranged inside in a radial direction of the stator 8 and is provided rotatably relative to the stator 8. The motor 2 of the first embodiment is a so-called brushless motor that does not require a brush when supplying electric power to the stator 8.

### (Motor Case)

The motor case 5 is formed of a material having excellent heat dissipation properties such as an aluminum alloy. The motor case 5 is constituted of a first motor case 6 and a second motor case 7 that are dividable in the axial direction. Each of the first motor case 6 and the second motor case 7 is formed in a cylindrical shape having a bottom.

The first motor case 6 is integrally molded with a gear case 40 of the speed reduction portion 3 such that a bottom portion 10 is connected to the gear case 40. A penetration hole 10a through which the rotation shaft 31 of the motor 2 is capable of being inserted is formed in the middle in the radial direction of the bottom portion 10.

Outer flange portions 16, 17 that extend outward in the radial direction are formed on opening portions 6a, 7a of the first motor case 6 and the second motor case 7, respectively. In the motor case 5, the outer flange portions 16, 17 confront each other, and an inner space is formed. The stator 8 and the rotor 9 are arranged in the inner space of the motor case 5. The stator 8 is fixed to the inner circumferential surface of the motor case 5.

### (Stator)

The stator 8 includes: a stator core 20 that is constituted of laminated electromagnetic steel plates or the like; and a plurality of coils 24 that is wound around the stator core 20. The stator core 20 includes: a stator core main body portion 21 having an annular shape; and a plurality of (for example, six) teeth portions 22 that protrudes inward in the radial direction from an inner circumferential section of the stator core main body portion 21. The inner circumferential surface of the stator core main body portion 21 and each teeth portion 22 are covered by an insulator 23 made of resin. The coil 24 is wound by a corresponding predetermined teeth portion 22 from an upper side of the insulator 23. Each coil 24 generates a magnetic field for rotating the rotor 9 by electric power supplied from the controller 4.

### (Rotor)

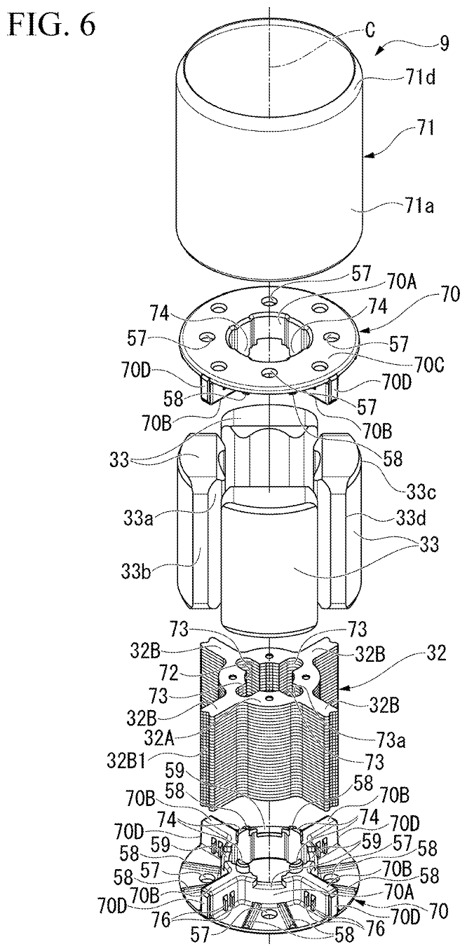

The rotor 9 is arranged rotatably via a minute gap on the inside in the radial direction of the stator 8. The rotor 9 includes: a rotor core 32 which has a cylindrical shape and in which the rotation shaft 31 is pressed into and fixed to an inner circumferential portion; and four magnets 33 (refer to FIG. 6) assembled to an outer circumferential portion of the rotor core 32. In the first embodiment, the rotation shaft 31 is integrally formed with a worm shaft 44 that constitutes the speed reduction portion 3. The rotation shaft 31 and the worm shaft 44 are rotatably supported by the motor case 5 and the gear case 40. The rotation shaft 31 and the worm shaft 44 rotate about a rotation axis line (axis center C). For example, a ferrite magnet is used as the magnet 33. However, the magnet 33 is not limited thereto, and a neodymium bond magnet, a neodymium sintered magnet, or the like can be also used.

The detailed structure of the rotor 9 will be described later.

### (Speed Reduction Portion)

The speed reduction portion 3 includes: the gear case 40 that is integrated with the motor case 5; and a worm speed reduction mechanism 41 that is stored in the gear case 40. The gear case 40 is formed of a metal material having excellent heat dissipation properties such as an aluminum alloy. The gear case 40 is formed in a box shape having an opening portion 40a on one surface. The gear case 40 has a gear accommodation portion 42 that accommodates the worm speed reduction mechanism 41 within the gear accommodation portion 42. An opening portion 43 that causes the gear accommodation portion 42 and the penetration hole 10a of the first motor case 6 to communicate with each other is formed on a sidewall 40b of the gear case 40 at a position where the first motor case 6 is integrally formed.

A bearing boss 49 having a cylindrical shape is provided to protrude on a bottom wall 40c of the gear case 40. The bearing boss 49 is a member that rotatably supports an output shaft 48 of the worm speed reduction mechanism 41. A sliding bearing (not shown) is arranged on an inner circumferential side of the bearing boss 49. An O-ring (not shown) is attached to the inside of a front end portion of the bearing boss 49. A plurality of ribs 52 for ensuring the stiffness is provided to protrude on the outer circumferential surface of the bearing boss 49.

The worm speed reduction mechanism 41 that is accommodated in the gear accommodation portion 42 is constituted of the worm shaft 44 and a worm wheel 45 that is engaged with the worm shaft 44. Both end portions in the axial direction of the worm shaft 44 are rotatably supported by the gear case 40 via the bearings 46, 47. The output shaft 48 of the motor 2 is provided coaxially and integrally with the worm wheel 45. The worm wheel 45 and the output shaft 48 are arranged such that rotation axis lines of the worm wheel 45 and the output shaft 48 are perpendicular to the rotation axis line (axis center C) of the worm shaft 44 (the rotation shaft 31 of the motor 2). The output shaft 48 protrudes to the outside via a bearing boss 49 of the gear case 40. A spline 48a that is connectable to a target object that is driven by the motor is formed on a protruding front end of the output shaft 48.

A sensor magnet (not shown) is provided on the worm wheel 45. The position of the sensor magnet is detected by a magnetic detection element 61 provided on the controller 4 described later. That is, the rotation position of the worm wheel 45 is detected by the magnetic detection element 61 of the controller 4.

### (Controller)

The controller 4 includes a controller board 62 on which the magnetic detection element 61 is provided. The controller board 62 is arranged within the opening portion 40a of the gear case 40 such that the magnetic detection element 61 faces the sensor magnet of the worm wheel 45. The opening portion 40a of the gear case 40 is closed by a cover 63.

End portions of a plurality of coils 24 drawn from the stator core 20 are connected to the controller board 62. A terminal of a connector 11 (refer to FIG. 1) provided on the cover 63 is electrically connected to the controller board 62. A power module (not shown) constituted of a switching element such as a FET (Field-Effect Transistor) that controls a drive voltage supplied to the coil 24, a capacitor (not shown) that smooths the voltage, and the like in addition to the magnetic detection element 61 are provided on the controller board 62.

### (Detailed Structure of Rotor)

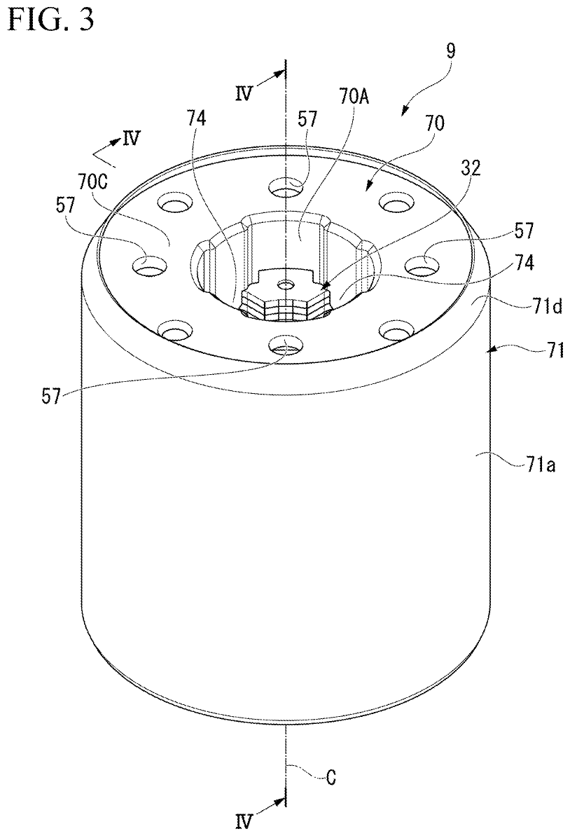

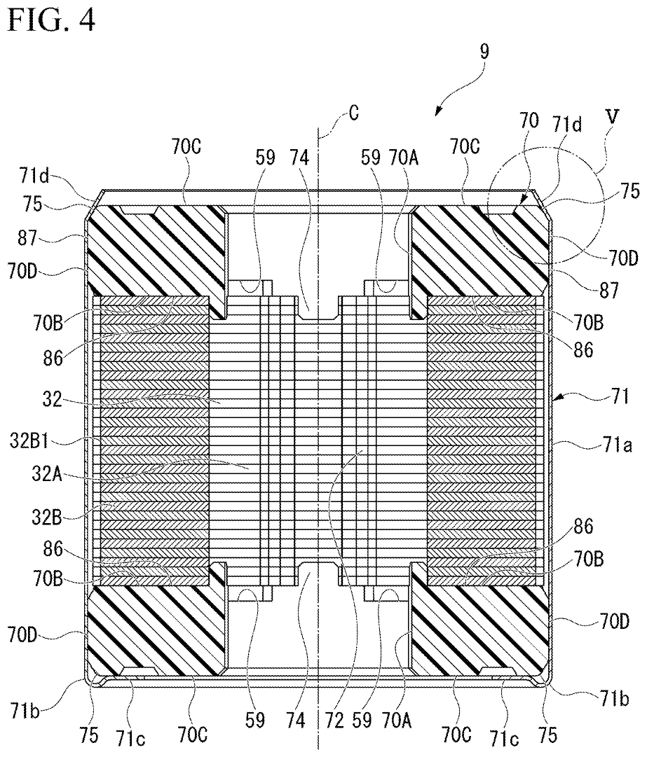

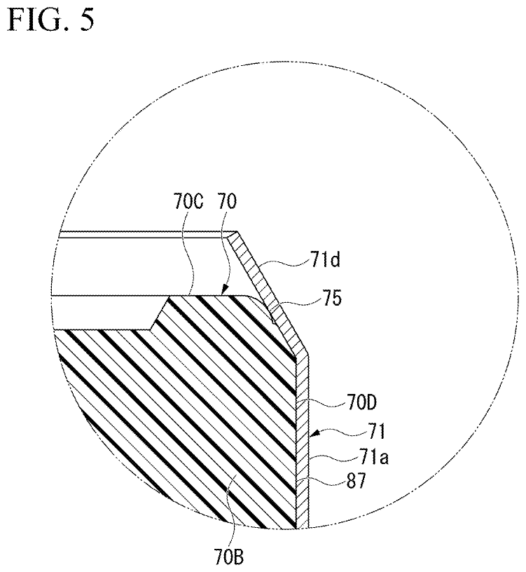

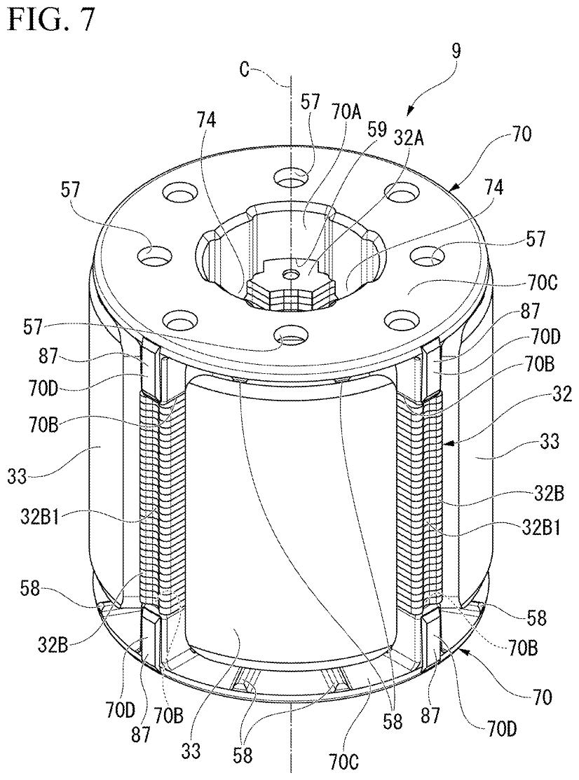

FIG. 3 is a perspective view of the rotor 9. FIG. 4 is a cross-sectional view along a IV-IV line of FIG. 3. FIG. 5 is an enlarged cross-sectional view of a V portion in FIG. 4 of the rotor 9. FIG. 6 is an exploded perspective view of the rotor 9. FIG. 7 is a perspective view of the rotor 9 from which a magnet cover 71 is removed.

As shown in FIG. 3 to FIG. 7, the rotor 9 includes: a rotor core 32 that rotates about the rotation axis line (axis center C) integrally with the rotation shaft 31 (refer to FIG. 2); four magnets 33 that are arranged on the outer circumferential surface of the rotor core 32; a pair of holders 70 that are arranged on one end side and the other end side in the axial direction of the rotor core 32; and a magnet cover 71 made of a metal, having a cylindrical shape, and covering the outsides of the magnet 33 and the rotor core 32 together with the pair of holders 70 from the outside in the radial direction and the axial direction.

The rotor core 32 includes a rotor core main body portion 32A (corresponding to a core main body portion in the claims) having a cylindrical shape and four salient poles 32B that protrude radially outward in the radial direction from the outer circumferential surface of the rotor core main body portion 32A. The rotor core 32 is formed, for example, by pressurized molding of a soft magnetic powder or by lamination in the axial direction of a plurality of electromagnetic steel plates.

A rotation shaft-holding hole 72 centered on the axis center C (rotation axis line) of the rotor 9 is formed on the rotor core main body portion 32A. The rotation shaft 31 is pressed into, is fixed by, and is held by the rotation shaft-holding hole 72. Thereby, the rotor core main body portion 32A is fitted to and is fixed by the rotation shaft 31.

Four escape grooves 73 that extend outward in the radial direction are formed on the inner circumferential surface of the rotation shaft-holding hole 72. The escape grooves 73 are arranged at equal intervals in the circumferential direction. Each escape groove 73 is in communication with the inside in the radial direction of the rotation shaft-holding hole 72. Each escape groove 73 is formed throughout the axial direction of the entire rotor core 32. An outer end portion in the radial direction of each escape groove 73 is an engagement portion 73a having an arc shape. A latch claw 74 of the holder 70 described later is fitted into the engagement portion 73a.

The four salient poles 32B protrude at equal intervals on the outer circumference of the rotor core main body portion 32A and extend in the axial direction. The four salient poles 32B are arranged between the magnets 33 that are adjacent to each other in the circumferential direction. The outer circumferential surface of the rotor core main body portion 32A is formed in a circular shape centered on the axis center C (rotation axis line) of the rotor 9. A side surface in the circumferential direction of each salient pole 32B is formed to be flat. An outer side surface 32B1 in the radial direction of the salient pole 32B is formed in a U shape that is recessed inward in the radial direction when seen from the axial direction. The magnet 33 is assembled to the rotor core 32 between the salient poles 32B that are adjacent to each other in the circumferential direction.

The magnet 33 is formed in an arc shape when seen from the axial direction. The inner circumferential surface of the magnet 33 is formed in an arc shape (an arc shape that substantially matches the outer circumferential surface of the rotor core main body portion 32A) centered on the axis center C (rotation axis line) of the rotor 9. On the other hand, the outer circumferential surface of the magnet 33 is formed in an arc shape having a smaller radius of curvature than the inner circumferential surface. In other words, the outer circumferential surface of the magnet 33 is formed in an arc shape centered on an eccentric position to the outer circumferential surface side in the radial direction further than the axis center C (rotation axis line) of the rotor 9.

That is, the magnet 33 is a so-called eccentric magnet. Therefore, the middle portion in the circumferential direction of the magnet 33 is a maximum expansion portion 33c of the magnet 33. The maximum expansion portion 33c is located at a slightly further outer position in the radial direction than the outer end portion in the radial direction of the salient pole 32B. The maximum expansion portion 33c is located at a further outer position in the radial direction than a circumferential direction end portion 33d in the outer circumferential surface of the magnet 33. The circumferential direction end portion 33d is located at substantially the same position in the radial direction as, or at a slightly further inner position in the radial direction than the radial direction outer end of the salient pole 32B.

The length in the axial direction of each magnet 33 is formed to be longer than the length in the axial direction of the salient pole 32B of the rotor core 32. Each magnet 33 is arranged such that one end side in the axial direction protrudes shorter than the other end side relative to the salient pole 32B in a state of being assembled to the rotor core 32.

A contact surface 33a that is in contact with a flat side surface of the salient pole 32B and an inclination surface 33b that extends from an outer end portion in the radial direction of the contact surface 33a to be inclined in a direction away from the salient pole 32B are provided on both end portions in an arc direction of the magnet 33. The magnet 33 is pressed into the magnet cover 71 together with the rotor core 32 and the holder 70 described later.

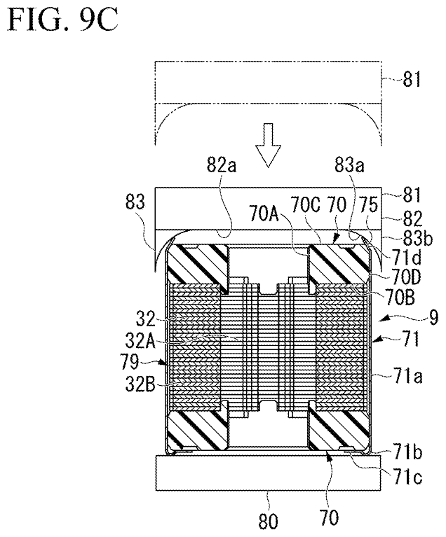

As shown in FIG. 10 described later, when the distance from the axis center C (rotation axis line) of the rotor 9 to the outer circumference of the rotor core main body portion 32A is L1 and the distance from the axis center C to the outer circumferential surface of the maximum expansion portion 33c of the magnet 33 is L2, the distance L2 is set to be in a range from 1.5 times to 2.0 times the distance L1. When the distance from the axis center C (rotation axis line) of the rotor 9 to the outer end in the radial direction of the salient pole 32B is L3, L3 is set to be in a range from 1.5 times to 2.0 times L1. Here, the distance L2 and the distance L3 satisfy L2>L3.

Thereby, since it is possible to increase the volume of the magnet 33, the effective magnetic flux is increased, and it is possible to improve the output of the motor 2. By increasing the size in the radial direction of the magnet 33, an interlinkage magnetic flux from the stator 8 does not easily pass through the magnet 33. By arranging the outer end in the radial direction of the salient pole 32B near the stator 8, the interlinkage magnetic flux from the stator 8 easily passes through the salient pole 32B. Therefore, a reluctance torque that attracts the salient pole 32B is increased by the interlinkage magnetic flux of the stator 8. Accordingly, it is possible to improve the output of the motor 2.

The magnet cover 71 includes: a cylindrical portion 71a that covers the outer circumferential surface of the rotor core 32 and the magnet 33; an expansion portion 71b that is integrally molded on one end (lower end in FIG. 4) in the axial direction of the cylindrical portion 71a; a first flange portion 71c (corresponding to a flange portion in the claims) integrally molded on an inner end in the radial direction of the expansion portion 71b; and a second flange portion 71d (corresponding to a flange portion in the claims) integrally molded on the other end (upper end in FIG. 4) in the axial direction of the cylindrical portion 71a.

The maximum value of the tolerance of the inner diameter in the cylindrical portion 71a before assembly is set to be equal to or less than the minimum value of the tolerance of the external size in the magnet 33 in a state of being assembled to the rotor core 32. Thereby, when the magnet cover 71 is inserted from the outside to the magnet 33, the magnet cover 71 is pressed into the magnet 33.

The expansion portion 71b is formed to protrude outward in the axial direction from one end in the axial direction of the cylindrical portion 71a and to be folded back inward in the radial direction. The expansion portion 71b is formed throughout the entire circumference of the cylindrical portion 71a.

The first flange portion 71c extends inward in the radial direction from an inner end in the radial direction at which the expansion portion 71b is folded back. An extension direction of the first flange portion 71c is along the radial direction.

The second flange portion 71d is formed by being plastically deformed to be bent inward in the radial direction by swaging in a state where the rotor core 32 and the magnet 33 together with the pair of holders 70 are arranged inside the cylindrical portion 71a. The details of the assembly method of the magnet cover 71 will be described later, and except for this description of the assembly method, the second flange portion 71d of the magnet cover 71 will be described as being swaged.

The pair of holders 70 is arranged on both end portions in the axial direction at the inside of the magnet cover 71.

### (Holder)

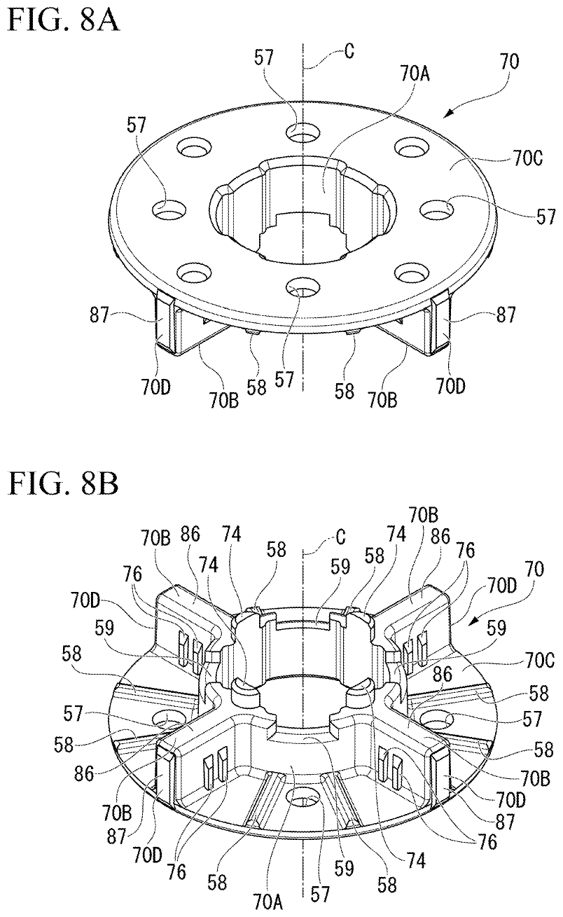

FIG. 8A is a perspective view of the holder 70 when seen from another end side in the axial direction. FIG. 8B is a perspective view of the holder 70 when seen from one end side in the axial direction.

As shown in FIG. 6, FIG. 7, FIG. 8A, and FIG. 8B, the pair of holders 70 each being arranged on each end in the axial direction of the rotor core 32 has the same configuration. Both of the holders 70 are assembled to the rotor core 32 in a state where upper and lower sides are inverted.

The holder 70 is formed of, for example, a rigid resin. The holder 70 is formed in a shape that substantially overlaps the rotor core 32 in an axial direction view. The holder 70 includes: an annular portion 70A that is arranged to overlap an end surface in the axial direction of the rotor core main body portion 32A of the rotor core 32; four leg portions 70B that radially protrude outward in the radial direction from the outer circumferential surface of the annular portion 70A; a substrate 70C that is provided on an end portion on the opposite side of the rotor core 32 in the axial direction in the annular portion 70A and the leg portion 70B; and a press fit rib 70D that is integrally formed on an outer end portion in the radial direction of each leg portion 70B.

Four latch claws 74 are integrally molded at equal intervals in the circumferential direction on an inner circumferential edge section of the annular portion 70A. The latch claw 74 protrudes toward the rotor core 32 side along the axial direction. The latch claw 74 is formed to have a semicircular cross section. The latch claw 74 is fitted to the escape groove 73 (engagement portion 73a) on the inner circumference of the rotor core 32 when the holder 70 is assembled to the end surface of the rotor core 32. Each latch claw 74 is fitted to a corresponding escape groove 73 (engagement portion 73a), and thereby the relative displacement of the holder 70 in the radial direction relative to the rotor core 32 is regulated.

Four recess portions 59 are formed at equal intervals in the circumferential direction on an inner end surface in the axial direction of the annular portion 70A. Each recess portion 59 extends along the circumferential direction. Each recess portion 59 is arranged between latch claws 74 that are adjacent to each other in the circumferential direction.

Four leg portions 70B are provided on each holder 70 such that the number of leg portions 70B is the same as the number of poles (the number of magnets 33).

The four leg portions 70B are formed to protrude outward in the radial direction from a position corresponding to the latch claw 74 on the outer circumference of the annular portion 70A. That is, the four leg portions 70B are arranged between the recess portions 59 that are adjacent to each other in the circumferential direction. The four leg portions 70B are arranged in a cross shape when seen from the axial direction. The thickness in the axial direction of each leg portion 70B is set to be thicker than the protrusion length of the magnet 33 from the salient pole 32B of the rotor core 32.

Each leg portion 70B is arranged to overlap an end surface in the axial direction of each salient pole 32B. Each leg portion 70B is formed such that an outer end section in the radial direction of the leg portion 70B and an outer end portion in the radial direction of the corresponding salient pole 32B of the rotor core 32 are at the same position when seen from the axial direction. That is, the outer end section in the radial direction of the leg portion 70B is located at a slightly further inner position in the radial direction than the maximum expansion portion 33c of the magnet 33 and is at the same position in the radial direction as the circumferential direction end portion 33d in the outer circumferential surface of the magnet 33.

The inner end surface in the axial direction of the leg portion 70B is on the same plane as the inner end surface in the axial direction of the annular portion 70A. Hereinafter, the inner end surfaces in the axial direction of the annular portion 70A and the leg portion 70B are collectively referred to as a contact surface 86. The contact surface 86 is in contact with the end surfaces in the axial direction of the rotor core main body portion 32A and the salient pole 32B of the rotor core 32. The contact surface 86 is separated into four blocks in the circumferential direction across the recess portion 59.

A pair of press fit protrusions 76 is formed on both side surfaces that face the circumferential direction of each leg portion 70B. Each press fit protrusion 76 extends along the axial direction and is formed such that the expansion height is gradually lowered toward a side close to the rotor core 32.

When the holder 70 is assembled to the rotor core 32 in which the magnet 33 is arranged on the outer circumferential portion, an end portion of each magnet 33 is inserted between the leg portions 70B that are adjacent to each other in the circumferential direction of the holder 70. At this time, the contact surface 33a of the magnet 33 comes into contact with the press fit protrusion 76. Thereby, the displacement in the circumferential direction of the magnet 33 is regulated.

The substrate 70C closes a space between the leg portions 70B that are adjacent to each other in the circumferential direction at an outer position in the axial direction of the leg portion 70B. Thereby, the substrate 70C is arranged to overlap the end surface in the axial direction of the magnet 33. The outer shape of the substrate 70C is a circular shape when seen from the axial direction. The radius of the substrate 70C is almost the same as the length from the axis center C of the rotor core 32 to the outer end section in the radial direction of the leg portion 70B. In the state where the pair of holders 70 is assembled to the rotor core 32, the separation distance in the axial direction between the pair of substrates 70C is longer than the length in the axial direction of the magnet 33. A round chamfered portion 75 is formed on the outer circumferential surface of the substrate 70C throughout the entire circumference. The round chamfered portion 75 is formed to protrude outward in the axial direction.

A confirmation hole 57 having a circular shape is formed at a position between the leg portions 70B that are adjacent to each other in the circumferential direction on the substrate 70C. The confirmation hole 57 is formed at a position that faces the end surface in the axial direction of each magnet 33. Thereby, when the holder 70 is assembled in the magnet cover 71 together with the rotor core 32 that holds the magnet 33, the position of each magnet 33 can be visually checked from the outside of the rotor core 32. Four confirmation holes 57 are provided so as to correspond to the magnets 33 in a one-to-one relationship.

An outer surface in the axial direction of the substrate 70C is formed to be flat. On the other hand, as shown in FIG. 8B, a plurality of reinforcement ribs 58 that radially extends is provided to protrude on an inner surface in the axial direction of the substrate 70C. Two reinforcement ribs 58 are arranged between the leg portions 70B that are adjacent to each other in the circumferential direction on the inner surface in the axial direction of the substrate 70C.

When performing die molding of the holder 70 using a resin, the reinforcement rib 58 has a function of preventing the occurrence of deformation such as depression or waving in the circumferential region of the substrate 70C due to a thermal sink or the like. The reinforcement rib 58 has a function of enhancing the mechanical strength of the substrate 70C. The reinforcement rib 58 faces an end surface in the axial direction of the magnet 33 when the holder 70 is assembled in the magnet cover 71 together with the rotor core 32 that holds the magnet 33. The reinforcement rib 58 regulates the displacement in the axial direction of the magnet 33 by coming into contact with the end surface of the magnet 33 when an excessive load acts in the axial direction on the magnet 33.

The press fit rib 70D protrudes outward in the radial direction from an outer end section in the radial direction of the leg portion 70B and the outer circumferential surface of the substrate 70C. Therefore, an outer end portion in the radial direction of the substrate 70C is located at a further inner position in the radial direction than the outer end portion in the radial direction of the press fit rib 70D throughout the entire circumference. The press fit rib 70D is formed such that the shape when seen from the radial direction corresponds to the shape of the outer end surface in the radial direction of the leg portion 70B. That is, the press fit rib 70D is formed in a rectangular shape that is elongated in the axial direction when seen from the radial direction.

The size of the press fit rib 70D when seen from the radial direction is smaller than the size of the outer end surface in the radial direction of the leg portion 70B. More specifically, the length in the axial direction of the press fit rib 70D is set to be a length of about 10 to 30% of the total length in the axial direction of the rotor 9 excluding the rotation shaft 31 (hereinafter, referred to as a rotor unit). More preferably, the length in the axial direction of the press fit rib 70D may be set to about 20% of the length in the axial direction of the rotor unit. The outer end portion in the axial direction of the press fit rib 70D is located at the outer circumferential surface of the substrate 70C.

In more detail with respect to the press fit rib 70D, the press fit rib 70D is formed in a trapezoidal shape that tapers outward in the radial direction when seen from each of the axial direction and the circumferential direction. An outer end surface 87 in the radial direction of the press fit rib 70D is formed in a shape that is curved along the outer circumferential surface of the substrate 70C when seen from the axial direction.

Since the press fit rib 70D is provided on each leg portion 70B, four press fit ribs 70D are provided on each holder similarly to the leg portion 70B such that the number of the press fit ribs 70D is the same as the number of poles. Since two holders 70 are provided, a total of eight press fit ribs 70D are provided as a whole.

As described above, each leg portion 70B is formed such that the outer end section in the radial direction of the leg portion 70B and the outer end portion in the radial direction of the corresponding salient pole 32B are at the same position when seen from the axial direction. That is, the outer end section in the radial direction of the leg portion 70B is located at a slightly further inner position in the radial direction than the maximum expansion portion 33c of the magnet 33 and is at the same position in the radial direction as the circumferential direction end portion 33d in the outer circumferential surface of the magnet 33. The radius of the substrate 70C is almost the same as the length from the axis center C of the rotor core 32 to the outer end section in the radial direction of the leg portion 70B.

On the other hand, the outer end portion in the radial direction of the press fit rib 70D protrudes further outward in the radial direction than the outer end portion in the radial direction of the salient pole 32B, the outer circumferential surface of the substrate 70C, and the circumferential direction end portion 33d in the outer circumferential surface of the magnet 33. The press fit rib 70D is located at substantially the same position in the radial direction as, or at a slightly further outer position in the radial direction than the maximum expansion portion 33c of the magnet 33.

The maximum value of the tolerance of the inner diameter in the cylindrical portion 71a of the magnet cover 71 before assembly is set to be equal to or less than the minimum value of the tolerance of the distance between the circumferential direction end portion 33d in the outer circumferential surface of the press fit rib 70D and the axis center C in a state of being assembled to the rotor core 32. Thereby, when the magnet cover 71 is inserted from the outside to the holder 70, the magnet cover 71 is pressed into the leg portion 70B of the holder 70 by the press fit rib 70D.

In the state where the magnet cover 71 is assembled to the rotor core 32 (hereinafter, referred to as an assembly state of the magnet cover 71), the inner circumferential surface of the cylindrical portion 71a of the magnet cover 71 is in contact with the outer circumferential surface of the press fit rib 70D and the maximum expansion portion 33c of the magnet 33. Here, in the present embodiment, the volume of the magnet 33 is large. Therefore, the magnet 33 may rattle with respect to the rotor core 32. Accordingly, by assembling the magnet cover 71 to be in contact with the maximum expansion portion 33c of the magnet 33, it is possible to effectively prevent rattling of the magnet 33 with respect to the rotor core 32.

### (Assembly Method of Magnet Cover)

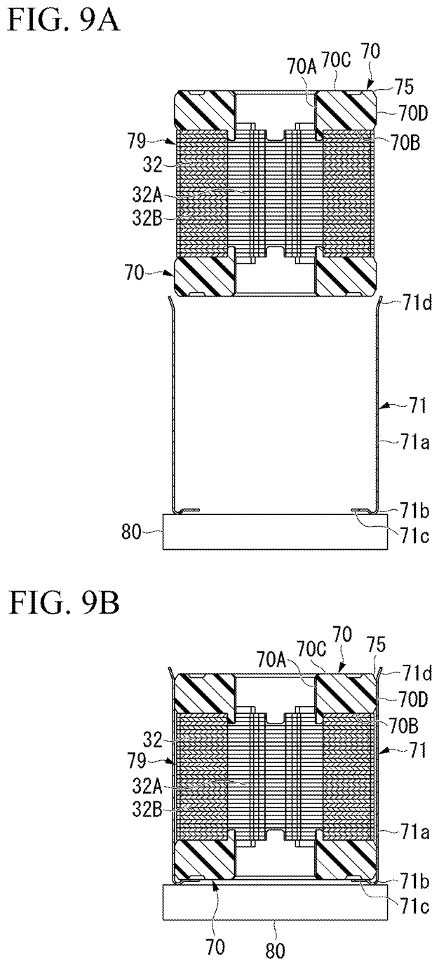

Next, an assembly method of the magnet cover 71 will be described with reference to FIG. 9A to FIG. 9C.

FIG. 9A, FIG. 9B, and FIG. 9C are process views showing an assembly method of the magnet cover 71.

### (Cover Arrangement Process)

First, before assembling the magnet cover 71, the magnet 33 is arranged on the outer circumferential portion of the rotor core 32 in advance. In this state, the holder 70 is tentatively assembled to each end surface in the axial direction of the rotor core 32. In the following description, this tentative assembly state is referred to as an auxiliary assembly 79.

As shown in FIG. 9A, in the state of the auxiliary assembly 79, the magnet cover 71 is arranged on one end side in the axial direction of the rotor core 32 such that the second flange portion 71d faces the rotor core 32 side (cover arrangement process). At this time, the second flange portion 71d is not swaged. The second flange portion 71d is formed to be broadened toward the end such that the opening area gradually increases toward the opposite side (the rotor core 32 side) of the expansion portion 71b. In this state, the expansion portion 71b is pressed from the upper side of the expansion portion 71b by a first tool 80.

### (Cover Push Process)

Subsequently, as shown in FIG. 9B, the magnet cover 71 is pushed and fitted into the auxiliary assembly 79 while pressing the expansion portion 71b by the first tool 80 (cover push process). At this time, the second flange portion 71d is formed to be broadened toward the end. Therefore, the magnet cover 71 is smoothly fitted into the auxiliary assembly 79.

In the cover push process, the magnet cover 71 is pushed until the first flange portion 71c comes into contact with the substrate 70C of the holder 70. The magnet cover 71 is pushed while being pressed into the magnet 33 (refer to FIG. 7) and the press fit rib 70D. Therefore, the magnet 33 is pulled in the push direction of the magnet cover 71. When the pushing of the magnet cover 71 is completed, the end portion in the axial direction of the magnet 33 is pressed against the substrate 70C of the holder 70 on the second flange portion 71d side.

### (Swaging Process)

Subsequently, as shown in FIG. 9C, after the magnet cover 71 is completely pushed into the auxiliary assembly 79, the second flange portion 71d is swaged to be folded back inward in the radial direction by a second tool 81 (swaging process).

Here, the second tool 81 includes a tool main body portion 82 having a circular plate shape and a press portion 83 having a cylindrical shape and extending in a plate thickness direction of the tool main body portion 82 from an outer circumferential edge of an end surface 82a at one end side in the axial direction of the tool main body portion 82. The outer diameter of the tool main body portion 82 is slightly larger than the outer diameter of the magnet cover 71. An inner circumferential surface 83a of the press portion 83 is located at an outer position in the radial direction of the tool main body portion 82 gradually toward a direction away from the tool main body portion 82. The inner circumferential surface 83a is formed in an arc shape that extends outward in the radial direction in a cross-sectional view in the radial direction. The inner circumferential surface 83a of the press portion 83 continues to the outer circumferential surface 83b at an end portion on the opposite side of the tool main body portion 82 in the axial direction. The outer circumferential surface 83b is on the same plane as the outer circumferential surface of the tool main body portion 82.

In such a swaging process performed using the second tool 81, first, the second tool 81 is arranged on the opposite side in the axially rearward direction of the first tool 80 across the magnet cover 71. Subsequently, the second tool 81 is arranged in the state where the press portion 83 faces the rotor core 32 side and such that the central axis of the tool main body portion 82 matches the central axis of the rotor core 32. Subsequently, the second tool 81 is pressed in the axial direction toward the magnet cover 71. Then, the inner circumferential surface 83a of the press portion 83 comes into contact with the second flange portion 71d. Further, the second tool 81 swages and plastically deforms the second flange portion 71d such that the second flange portion 71d is bent inward in the radial direction.

The second flange portion 71d pushes the holder 70 from the outside in the axial direction at an outside position in the radial direction. Thereby, the magnet cover 71 is swaged and fixed to the holder 70 at the second flange portion 71d. Since the second flange portion 71d is plastically deformed, the rotor core 32 and the magnet 33 (refer to FIG. 7) together with the holder 70 are fixed to the inside of the magnet cover 71.

In this way, the assembly of the magnet cover 71 is completed.

In the first embodiment described above, since the magnet cover 71 is pressed and fitted into the press fit rib 70D of the holder 70 in addition to press-fitting to the magnet 33, it is possible to prevent the magnet cover 71 from coming into contact with the salient pole 32B and reduce the press fit load when performing press-fitting of the magnet cover 71. By reducing the press fit load, it is possible to prevent breakage of the magnet cover 71, the holder 70, and the magnet 33. Further, by reducing the press fit load, the deformation amount to the inside in the radial direction and to the outside in the radial direction of the magnet cover 71 caused by press-fitting can be reduced. Therefore, the magnet cover 71 and the magnet 33 can be fixed to the rotor core 32 without rattling.

In addition, at the time of the press-fitting, the magnet cover 71 is pulled outward in the radial direction by the magnet 33, and simultaneously, the salient pole-facing portion of the magnet cover 71 is pulled outward in the radial direction by the press fit rib 70D. Therefore, deformation of the magnet cover 71 shrinking inward in the radial direction in the entire circumferential direction is prevented, and deformation of the entire magnet cover 71 can be reliably prevented. Hereinafter, this is described in detail.

FIG. 10 is a view showing deformation prevention of the magnet cover 71 by the press fit rib 70D. FIG. 10 is a cross-sectional view in the axial direction of the rotor 9. In FIG. 10, the shape of the magnet cover 71 pressed into the magnet 33 is schematically shown using a two-dot chain line and a single-dot chain line. The two-dot chain line shows the shape of the magnet cover 71 when the press fit rib 70D is not provided. The single-dot chain line shows the shape of the magnet cover 71 when the press fit rib 70D is provided. In FIG. 10, the shape of the magnet cover 71 is described in an exaggerated manner in order to facilitate seeing the deformation amount of the magnet cover 71. Actually, the magnet cover indicated by the two-dot chain line is in contact with the salient pole 32B and the maximum expansion portion 33c of the magnet 33, and the magnet cover indicated by the single-dot chain line is in contact with the press fit rib 70D and the maximum expansion portion 33c of the magnet 33.

As shown in FIG. 10, when the press fit rib 70D is not provided, a magnet facing portion of the magnet cover 71 is deformed to be pulled outward in the radial direction, and the salient pole-facing portion of the magnet cover 71 is deformed to shrink inward in the radial direction. Thereby, the circumferential direction end portion 33d in the outer circumferential surface of each magnet 33 is tightened by the magnet cover 71, and a biased load is generated at the circumferential direction end portion 33d.

On the other hand, when the press fit rib 70D is provided as in the first embodiment, the deformation of shrinking inward in the radial direction is prevented even at the salient pole-facing portion of the magnet cover 71 by the press fit rib 70D compared to the case where the press fit rib 70D is not provided. The deformation of being pulled outward in the radial direction at the magnet facing portion of the magnet cover 71 is prevented in accordance with the deformation prevention at the salient pole-facing portion of the magnet cover 71. Thereby, it is possible to maintain a force that holds the maximum expansion portion 33c of the magnet 33 by the magnet cover 71. Tightening of the circumferential direction end portion 33d in the outer circumferential surface of each magnet 33 by the magnet cover 71 is prevented. Accordingly, generation of a biased load at the circumferential direction end portion 33d is prevented. The circumferential direction end portion 33d of the magnet 33 is arranged at a further inner side in the radial direction than the maximum expansion portion 33c and the press fit rib 70D. Therefore, it is possible to prevent the magnet cover 71 from easily coming into contact with the circumferential direction end portion 33d of the magnet 33.

Variation of the press fit load of the magnet cover 71 occurs due to manufacturing tolerance of the magnet 33, and the assembly is unstable. On the other hand, in the first embodiment, the press fit rib 70D is formed such that the press fit load at the press fit rib 70D is equal to or more than the press fit load at the magnet 33. Thereby, the variation of the press fit load due to manufacturing tolerance of the magnet 33 can be ignored to some extent. Hereinafter, this is described in detail.

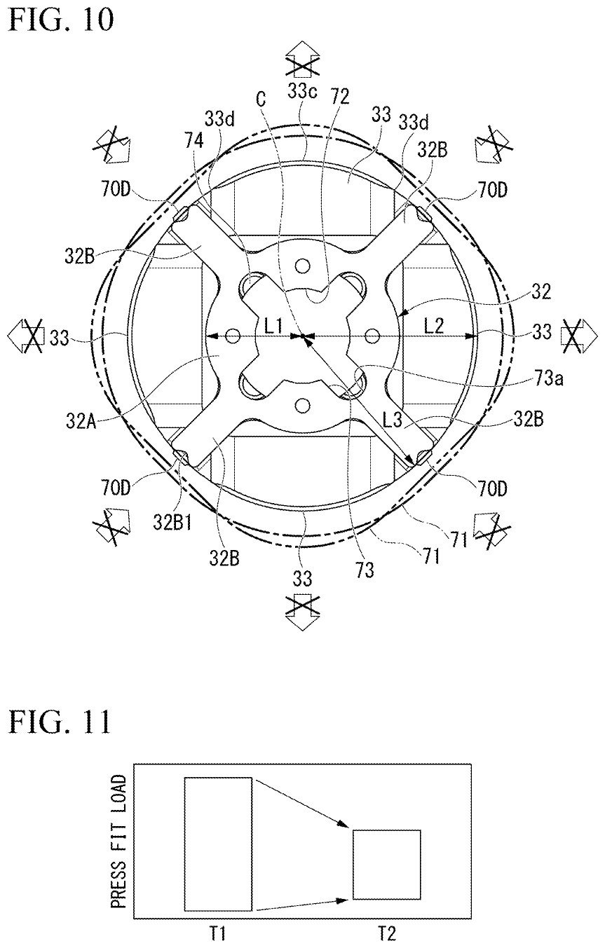

FIG. 11 is a graph showing the effects of preventing variation of a press fit load by the press fit rib 70D when the vertical axis represents a press fit load applied to the magnet cover 71 and the horizontal axis represents a result T1 when the press fit rib 70D is not provided and a result T2 when the press fit rib 70D is provided.

As shown in FIG. 11, when the press fit rib 70D is provided, it is confirmed that the minimum value of the press fit load is increased and the maximum value of the press fit load is decreased compared to the case where the press fit rib 70D is not provided.

The increase in the minimum value of the press fit load is caused by the press fit rib 70D being provided on the holder 70 and the holder 70 being also pressed into the magnet cover 71 in addition to the magnet 33.

The reduction in the maximum value of the press fit load is because dragging of the magnet cover 71 by the salient pole 32B described in detail below is prevented.

When the press fit rib 70D is not provided on the holder 70, the salient pole-facing portion of the magnet cover 71 shrinks inward in the radial direction at the time of press-fitting of the magnet cover 71. Therefore, the salient pole-facing portion of the magnet cover 71 comes into contact with the salient pole 32B. Then, the friction resistance between the magnet cover 71 and the salient pole 32B increases, and a larger press fit load is required. At this time, variation in the contact between each salient pole 32B and the salient pole-facing portion of the magnet cover 71 occurs, and this causes the occurrence of a biased load due to dragging at the time of press-fitting of the magnet cover 71. In particular, when the rotor core 32 is formed of a laminate body of a plurality of electromagnetic steel plates, the rotor core 32 is hard and has minute irregularities along the axial direction. Therefore, the friction resistance is larger than that of a resin member or the like.

On the other hand, in the first embodiment, the magnet cover 71 is pressed and fitted into the holder 70 by the press fit rib 70D. Thereby, the distance between the magnet cover 71 and the salient pole 32B in the radial direction is increased as compared to the case where the press fit rib 70D is not provided. As a result, the magnet cover 71 does not easily come into contact with the salient pole 32B. Even if the salient pole-facing portion of the magnet cover 71 is deformed inward in the radial direction, it is possible to prevent the magnet cover 71 and the salient pole 32B from strongly coming into contact with each other. Thereby, the friction resistance between the magnet cover 71 and the salient pole 32B becomes small, and it is possible to reduce the press fit. Accordingly, it is possible to prevent the occurrence of a biased load at the time of press-fitting of the magnet cover 71. Accordingly, it is possible to prevent the press fit load from becoming excessively large and prevent deformation or breakage of the magnet cover 71, the holder 70, and the magnet 33, and it is possible to stabilize the assembly of the magnet cover 71.

It is also conceivable that by pressing the salient pole 32B also into the magnet cover 71, the fixation strength of the magnet cover 71 to the rotor core 32 is enhanced, and rattling of the magnet cover 71 is prevented. However, in such a configuration, since the salient pole 32B is formed throughout the entire axial direction, the press fit area of the magnet cover 71 becomes large. Therefore, the press fit load of the magnet cover 71 becomes too large.

On the other hand, in the first embodiment, by providing the press fit rib 70D on the holder 70 and performing the press-fitting of the press fit rib 70D in place of the salient pole 32B, deformation of the magnet cover 71 is prevented. Since the length in the axial direction of the press fit rib 70D is sufficiently short relative to the salient pole 32B, the press fit load of the magnet cover 71 can be small compared to the case where the magnet cover 71 is dragged with respect to the salient pole 32B.

Further, since the magnet cover 71 is pressed into the press fit rib 70D, the holder 70 is strongly fixed to the magnet cover 71. Accordingly, it is not necessary to strongly fix the holder 70 to the magnet cover 71, the rotor core 32, and the magnet 33 by swaging, and a swaging load can be reduced. Hereinafter, this is described in detail.

That is, when the press fit rib 70D is not provided on the holder 70, it is conceivable that the second flange portion 71d of the magnet cover 71 is strongly swaged to the holder 70 in the swaging process in order to fix the holder 70 to the magnet cover 71 without rattling. At this time, since the swaging load becomes large, the end portion in the axial direction of the magnet cover 71 may be deformed to be expanded outward in the radial direction, or buckling may occur.

On the other hand, in the first embodiment, since the magnet cover 71 is pressed into the press fit rib 70D in the cover push process, the holder 70 is fixed by the magnet cover 71 without rattling. Therefore, in the swaging process, it is sufficient to swage the second flange portion 71d to the extent that the second flange portion 71d is hung by the holder 70, and it is possible to reduce the swaging load. By reducing the swaging load, it is possible to prevent deformation of the magnet cover 71. When the swaging load is reduced, an inner portion in the radial direction of the second flange portion 71d is assembled in a state of floating outward in the axial direction from the round chamfered portion 75 of the substrate 70C (refer to FIG. 5).

As described above, by reducing the press fit load and the swaging load, it is possible to reduce the energy required for press-fitting and swaging. Thereby, the reduced energy can be used for other processes or the like, and therefore it is possible to contribute to global energy efficiency improvement. Accordingly, it is possible to contribute to goal 7 “ensure access to affordable, reliable, sustainable, and modern energy for all” of the sustainable development goals (SDGs) of the United Nations initiative.

The outer end portion in the radial direction of the press fit rib 70D protrudes further outward in the radial direction than the outer circumferential surface of the magnet 33. Thereby, it is possible to easily form the press fit rib 70D.

The holder 70 includes the substrate 70C arranged to overlap the end surface in the axial direction of the magnet 33. Thereby, it is possible to regulate movement in the axial direction of the magnet 33 by the substrate 70C. As a result, it is possible to stabilize the position of the magnet 33. Further, the outer end portion in the radial direction of the substrate 70C is located at a further inner position in the radial direction than the outer end portion in the radial direction of the press fit rib 70D throughout the entire circumference. Thereby, it is possible to prevent the magnet cover 71 from being pressed into the entire portion in the circumferential direction of the holder 70. Therefore, it is possible to prevent the press fit load of the magnet cover 71 from being unnecessarily increased. At the time of press-fitting of the magnet cover 71, the substrate 70C does not come into contact with the magnet cover 71. Therefore, it is possible to prevent the substrate 70C from interfering with the press-fitting of the magnet cover 71.

The motor 2 includes the rotor 9 described above. Therefore, the motor 2 can reduce the deformation amount of the magnet cover 71. The magnet cover 71 and the magnet 33 can be fixed to the rotor core 32 without rattling.

The four leg portions 70B are arranged in a cross shape when seen from the axial direction. Thereby, a section of the leg portion 70B becomes thicker in the axial direction than a section of the substrate 70C only, and the strength is improved. Accordingly, the leg portion 70B can sufficiently receive the press fit load from the magnet cover 71 via the press fit rib 70D and can favorably prevent deformation of the magnet cover 71.

The plurality of reinforcement ribs 58 is provided to protrude on an inner surface in the axial direction of the substrate 70C. By providing the reinforcement rib 58, it is possible to prevent the substrate 70C of the holder 70 from being deformed by the swaging load at the time of swaging of the end portion of the magnet cover 71.

The contact surface 86 of the holder 70 is separated into four blocks in the circumferential direction across the recess portion 59.

Thereby, it is possible to facilitate adjustment of the molding die for causing the end surface of each block in the contact surface 86 to accurately come into contact with the end surface in the axial direction of the rotor core 32.

In the cover push process, the second flange portion 71d is formed to be broadened toward the end. Thereby, the magnet cover 71 can be easily fitted into the auxiliary assembly 79.

The expansion portion 71b is formed to protrude outward in the axial direction from one end in the axial direction of the cylindrical portion 71a and to be folded back inward in the radial direction. Thereby, in the cover push process, it is possible to prevent the corner of the magnet cover 71 from interfering with the outer circumferential edge of the holder 70 (the round chamfered portion 75 of the substrate 70C, and an outer corner portion in the axial direction of the press fit rib 70D). Therefore, the first flange portion 71c can be reliably in contact with the substrate 70C of the holder 70. Accordingly, it is possible to improve the assembly accuracy of the magnet cover 71.

The first flange portion 71c extends from the inner end in the radial direction at which the expansion portion 71b is folded back. Therefore, in the cover push process, when the magnet cover 71 is pushed until the magnet cover 71 comes into contact with the substrate 70C of the holder 70, for example, the edge at the inner end in the radial direction of the expansion portion 71b is prevented from hitting the substrate 70C, and the substrate 70C is prevented from becoming damaged.

The magnet 33 is formed such that the distance L2 from the axis center C of the rotor 9 to the outer circumferential surface of the maximum expansion portion 33c of the magnet 33 is set to be in a range from 1.5 times to 2.0 times the distance L1 from the axis center C to the outer circumference of the rotor core main body portion 32A. Further, the magnet 33 is formed such that the distance L3 from the axis center C of the rotor 9 to the radial direction outer end of the salient pole 32B is set to be in a range from 1.5 times to 2.0 times the distance L1. Therefore, it is possible to increase the volume of the magnet 33. The thickness in the radial direction of the magnet 33 can be as thick as possible. As a result, the interlinkage magnetic flux (magnetic field) by the stator does not easily pass through the magnet 33. Since the interlinkage magnetic flux does not pass through the magnet 33, the interlinkage magnetic flux easily flows through the salient pole 32B of the rotor core 32. By arranging the outer end in the radial direction of the salient pole 32B near the stator 8, the interlinkage magnetic flux from the stator 8 can easily pass through the salient pole 32B.

In the rotor 9 having the salient pole 32B as in the present embodiment, the salient pole 32B generates a reluctance torque that rotates the rotor core 32 such that the magnetic resistance (reluctance torque) of the magnetic path of the interlinkage magnetic flux becomes small. Therefore, the interlinkage magnetic flux easily flows through the salient pole 32B, and thereby as large a reluctance torque as possible can be generated. By forming as large a salient pole 32 as possible, the interlinkage magnetic flux easily flows through the salient pole 32B. Therefore, as large a reluctance torque as possible can be generated. Accordingly, it is possible to enhance the motor efficiency of the motor 2.

By increasing the volume of the magnet 33, there is a possibility that the magnet 33 rattles with respect to the rotor core 32.

Here, in the assembly state of the magnet cover 71, the inner circumferential surface of the cylindrical portion 71a of the magnet cover 71 is in contact with the outer circumferential surface of the press fit rib 70D and the maximum expansion portion 33c of the magnet 33. Therefore, it is possible to effectively prevent rattling of the magnet 33 with respect to the rotor core 32.

The first embodiment is described using an example in which, in the state where the pair of holders 70 is assembled to the rotor core 32, the separation distance in the axial direction between the pair of substrates 70C is longer than the length in the axial direction of the magnet 33; however, the embodiment is not limited thereto. The separation distance in the axial direction between the pair of substrates 70C may be equal to the length in the axial direction of the magnet 33. In this case, in the state where the rotor core 32, the magnet 33, and the holder 70 are assembled to the inner portion of the magnet cover 71, the magnet 33 is arranged to protrude to one end side and the other end side in the axial direction by approximately the same length relative to the salient pole 32B. In this case, the magnet 33 is in contact with both of the pair of substrates 70C.

### Second Embodiment

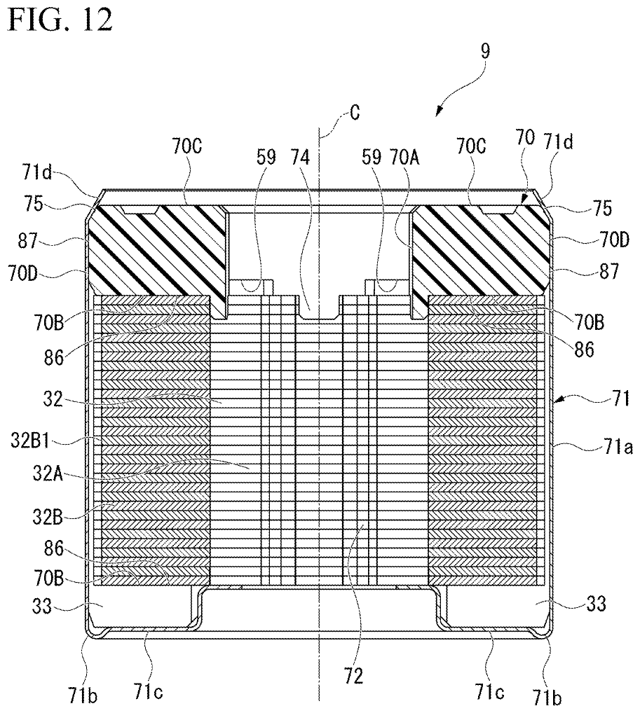

Subsequently, a second embodiment of the present invention will be described with reference to FIG. 12. Configurations of the second embodiment similar to those of the first embodiment are given the same reference numerals, and descriptions thereof are appropriately omitted.

FIG. 12 is a cross-sectional view of the rotor 9. FIG. 12 is a cross-sectional view in the radial direction of the rotor 9.

As shown in FIG. 12, the difference between the second embodiment and the first embodiment described above is that the holder 70 is arranged only on an end portion on the second flange portion 71d side of both end portions in the axial direction in the inside of the magnet cover 71 or the like.

The rotor 9 includes only one holder 70. Therefore, the number of the press fit ribs 70D provided is four, which is the same as the number of poles.

The first flange portion 71c of the magnet cover 71 is directly swaged to the magnet 33 and the rotor core 32. The first flange portion 71c is formed to be bent and adhered to the end surface in the axial direction of the magnet 33, the inner circumferential surface of the magnet 33, and the end surface in the axial direction of the rotor core 32.

In the second embodiment described above, the holder 70 is arranged only on the end portion on the second flange portion 71d side of both end portions in the axial direction in the inside of the magnet cover 71. Thereby, while achieving the effects of the first embodiment described above, it is possible to reduce the size and the weight of the rotor 9 as compared to the case where the holder 70 is provided on both end portions in the axial direction in the inside of the magnet cover 71.

Although preferred embodiments of the present invention have been described, the present invention is not limited to these embodiments. Additions, omissions, substitutions, and other modifications of the configuration can be made without departing from the scope of the present invention. The present invention is not limited by the above description and is limited only by the appended claims.

The above embodiments are described using an example in which the outer end portion in the axial direction of the press fit rib 70D is provided on the outer end section in the radial direction of the leg portion 70B; however, the embodiment is not limited thereto. The press fit rib 70D may be provided on a portion of the magnet cover 71 that faces, in the radial direction, the outer end section in the radial direction of the leg portion 70B. The press fit rib 70D may be provided on both of the outer end section in the radial direction of the leg portion 70B and the portion of the magnet cover 71 that faces, in the radial direction, the outer end section in the radial direction of the leg portion 70B.

The above embodiment is described using an example in which the outer end portion in the radial direction of the press fit rib 70D is located at substantially the same position in the radial direction as, or at a slightly further outer position in the radial direction than the maximum expansion portion 33c of the magnet 33; however, the embodiment is not limited thereto. It is sufficient for the outer end portion in the radial direction of the press fit rib 70D to protrude further outward in the radial direction than the circumferential direction end portion 33d in the outer circumferential surface of the magnet 33, and the outer end portion in the radial direction of the press fit rib 70D may be located at a further inner position in the radial direction or a further outer position in the radial direction than the maximum expansion portion 33c.

The above embodiment is described using an example in which the magnet 33 is an eccentric magnet; however, the embodiment is not limited thereto. The outer circumferential surface of the magnet 33 may be formed in an arc shape having the same radius of curvature as that of the inner circumferential surface.

The components in the embodiments described above can be appropriately replaced with known components without departing from the scope of the invention, and the modification examples described above may be suitably combined.

### INDUSTRIAL APPLICABILITY

According to the rotor and the motor described above, a magnet cover can be reliably assembled to a rotor core while relaxing the press fit load of the magnet cover to a salient pole.

### DESCRIPTION OF THE REFERENCE SYMBOLS

1 Motor unit
2 Motor
3 Speed reduction portion
4 Controller
Motor case
6 First motor case
6a Opening portion
7 Second motor case
7a Opening portion
8 Stator
9 Rotor
10 Bottom portion
10a Penetration hole
11 Connector
16 Outer flange portion
17 Outer flange portion
20 Stator core
21 Stator core main body portion
22 Teeth portion
23 Insulator
24 Coil
31 Rotation shaft
32 Rotor core
32A Rotor core main body portion (core main body portion)
32B Salient pole
32B1 Side surface
33 Magnet
33a Contact surface
33b Inclination surface
33c Maximum expansion portion
33d Circumferential direction end portion
40 Gear case
40a Opening portion
40b Sidewall
40c Bottom wall
41 Worm speed reduction mechanism
42 Gear accommodation portion
43 Opening portion
44 Worm shaft
45 Worm wheel
46 Bearing
47 Bearing
48 Output shaft
48a Spline
49 Bearing boss
52 Rib
57 Confirmation hole
58 Reinforcement rib
59 Recess portion
61 Magnetic detection element
62 Controller board
63 Cover
70 Holder
70A Annular portion
70B Leg portion
70C Substrate
70D Press fit rib
71 Magnet cover
71a Cylindrical portion
71b Expansion portion
71c First flange portion (flange portion)
71d Second flange portion (flange portion)
72 Rotation shaft-holding hole
73 Groove
73a Engagement portion
74 Latch claw
75 Round chamfered portion
76 Press fit protrusion
79 Auxiliary assembly
80 First tool
81 Second tool
82 Tool main body portion
82a End surface
83 Press portion
83a inner circumferential surface
83b Outer circumferential surface
86 Contact surface
87 End surface
C Axis center
T1 Result
T2 Result

1. A rotor comprising:
a rotor core that rotates integrally with a rotation shaft;
a plurality of magnets that are arranged on an outer circumferential surface of the rotor core;
a magnet cover which covers an outside of the magnets and the rotor core, into which the magnets are pressed, which includes a flange portion that is formed on an end portion in an axial direction and is bent inward in a radial direction, and which has a cylindrical shape; and
a holder that is arranged between the flange portion and an end surface in an axial direction of the rotor core and is in contact with the flange portion and the rotor core,
wherein the rotor core includes:
a core main body portion that is fitted and fixed to the rotation shaft and has a cylindrical shape; and
a plurality of salient poles that protrude outward in a radial direction from the core main body portion and are arranged between the magnets which are adjacent to each other in a circumferential direction,
the holder includes:
an annular portion that is arranged to overlap an end surface in an axial direction of the core main body portion; and
a leg portion that protrudes outward in a radial direction from the annular portion and is arranged to overlap an end surface in an axial direction of the salient poles, and
a press fit rib in which the magnet cover is pressed into the leg portion is provided on at least one of an outer end section in a radial direction of the leg portion and a portion of the magnet cover that faces, in a radial direction, the outer end section in the radial direction of the leg portion.

2. The rotor according to claim 1,
wherein the press fit rib is provided on the outer end section in the radial direction of the leg portion, and
an outer end portion in a radial direction of the press fit rib protrudes further outward in the radial direction than a circumferential direction end portion in the outer circumferential surface of the magnet.

3. The rotor according to claim 2,
wherein the holder includes:
a substrate that is provided on an end portion on an opposite side of the rotor core in an axial direction in the annular portion and the leg portion, is arranged to overlap an end surface in an axial direction of the magnet, and has a circular outer shape when seen from the axial direction, and
an outer end portion in a radial direction of the substrate and that is located at a further inner position in the radial direction than the outer end portion in the radial direction of the press fit rib throughout an entire circumference.

4. The rotor according to claim 1,
wherein, in the radial direction, the magnet cover is in contact with a circumferential direction middle portion of the press fit rib and the magnet.

5. The rotor according to claim 4,
wherein the magnet is formed in an arc shape when seen from the axial direction, and
an outer circumferential surface of the magnet is formed in an arc shape centered on an eccentric position to an outer circumferential surface side of the magnet further than a rotation axis line of the rotation shaft.

6. The rotor according to claim 1,
wherein when seen from the axial direction, a distance from a rotation axis line of the rotation shaft to an outer circumferential surface of a circumferential direction middle portion of the magnet is in a range from 1.5 times to 2.0 times a distance from the rotation axis line of the rotation shaft to an outer circumferential surface of the core main body portion, and
when seen from the axial direction, a distance from the rotation axis line of the rotation shaft to a radial direction outer end of the salient poles is in a range from 1.5 times to 2.0 times the distance from the rotation axis line of the rotation shaft to the outer circumferential surface of the core main body portion.

7. A motor comprising:
the rotor according to claim 1; and
a stator that is arranged at a further outer side in the radial direction than the rotor and generates a magnetic field.
